(19) United States
(12) Patent Application Publication
(10) Pub. No.: US 2016/0114540 A1
(43) Pub. Date: Apr. 28, 2016

(54) BI-DIRECTIONAL FIBER APPLICATION HEAD WITH TWO ROLLERS

(71) Applicant: CORIOLIS COMPOSITES, LYON (FR)

(72) Inventors: Alexander Hamlyn, Ploemeur (FR); Loïc Gaillard, Lanouee (FR)

(73) Assignee: CORIOLIS COMPOSITIES, Lyon (FR)

(21) Appl. No.: 14/898,535

(22) PCT Filed: Jun. 17, 2014
(86) PCT No.: PCT/FR2014/000135

§ 371 Date: Dec. 15, 2015

(30) Foreign Application Priority Data
Jun. 18, 2013 (FR) 1301418

(51) Int. Cl. B29C 70/38

(52) U.S. Cl. CPC B29C 70/384

(57) ABSTRACT

A fiber application head and a method for producing parts made of composite materials by means of a corresponding head. The head comprises two application rollers, including a first roller and a second roller, each roller being movably mounted in relation to the main guiding system between at least an active position in which the band is capable of being guided by the main guiding system on the roller, and an inactive position in which the roller is remote from the main guiding system. The head comprises an actuating system able to maneuver the first roller into the active position and the second roller into the inactive position to apply a band by means of the first roller, and to maneuver the first roller into the inactive position and the second roller into the active position to apply a band by means of the second roller.

### RELATED CASES

The present application is a National Phase entry of PCT Application No. PCT/FR2014/000135, filed Jun. 17, 2014, which claims priority from FR Patent Application No. 1301418, filed Jun. 18, 2013, which applications are hereby incorporated by reference in their entireties.

### TECHNICAL FIELD

The present invention relates to a fiber application head for producing parts made of composite materials, and more particularly a bidirectional fiber application head comprising two rollers for the application of fibers in two opposite directions. The present invention also relates to a method for making composite material parts by means of a corresponding application head.

### BACKGROUND ART

There are known fiber application machines for the application in contact on a layup tool, such as a male or female mold, of a wide band formed of one or more continuous flat fibers, of tow type, dry or impregnated with thermosetting or thermoplastic resin, particularly of carbon fibers, consisting of a multitude of carbon threads or filaments.

These machines typically comprise a system for the displacement of a fiber application head, the head comprising an application roller intended to come into contact against the mold to apply the band, and a guiding system for guiding one or several applied fibers on the roller.

In the case of a band formed of several fibers, the guiding system of these application machines, also called fiber placement machines, make it possible to bring the fibers substantially edge to edge on the roller in the form of a band. Such as described particularly in patent document WO2008132299, the guiding system typically comprises first means and second means arranged in staggered rows along two guide planes approaching each other from upstream to downstream to guide the fibers towards the roller in the form of two layers of fibers, these guiding means comprise for example channels formed at the assembly interface of three plates. The head further comprises cutting means for cutting each fiber individually, and rerouting means for rerouting each newly cut fiber in order to be able to stop and restart the application of a band at any time, as well as to choose the width of the band.

After application of a first band in a direction, the application of the next band, parallel to the first, is typically carried out in the reverse direction after having performed a 180° rotation of the head, or in the same direction as the first band, having brought the head backwards to the starting point of the first band. These operations of displacement of the head between the application of two bands significantly increase the time for laying up the fibers.

To reduce this laying up time, there are known heads, so-called bidirectional, allowing the application of fibers in two opposite directions. It has been proposed, particularly in patent document US2005/0061422, to provide an application head comprising two guiding systems independent from one another, arranged symmetrically on either side of the application roller, for applying a band in two opposite directions by using one or the other guiding systems. Such a head equipped with two guiding systems, each associated with its own cutting system and its own rerouting system, proves cumbersome and heavy, which limits the speed for laying up the fibers and does not allow the application of fibers on molds with large convexity and/or concavity. In addition, each guiding system must be associated to a different fiber storage means, which increases the complexity of the application machine.

It has also been proposed, particularly in patent document US 2009/0139654, to provide a head equipped with a guiding system which comprises for each fiber a guiding element movable between a first position and a second position to bring the fiber to one side or the other of the roller, each guiding element being maneuvered between its two positions by its own actuating system. These guiding systems are complex and bulky, and require several separate rollers. Two adjacent fibers of a band must be applied by different rollers, each associated to its own guiding system, and offset from each other in the application direction. The resulting head also has large dimensions, and cannot be used for making parts with large convexity or concavity.

It has also been proposed, particularly in patent document FR 2 982 793, to provide a bi-directional application head, comprising an application roller movably mounted in relation to the main guiding system between a first position, in which the band is guided by the main guiding system on a first part of the cylindrical surface of the roller, so that the application of the band is achieved by rotation of the roller in a first rotational direction, and a second position in which the band is guided on a second part of the cylindrical surface of the roller, so that the application of the band is achieved by rotation of the roller in the second rotational direction. These bidirectional heads, simple in design and implementation, and of small dimensions, guarantee a fiber application speed substantially similar to that of a mono-directional head, and make it possible to reduce the laying up time. However, some rollers, notably rollers made of flexible material, tend to deteriorate more quickly or have an uncontrolled deformation when they are used in the direction of rotation for which they are not intended.

The purpose of the present invention is to propose a new solution aiming to overcome at least one of the aforementioned disadvantages, and in particular to at least limit the laying up time.

### SUMMARY OF THE INVENTION

To this end, embodiments of the present invention provides a fiber application head for producing parts made of composite material, comprising at least one application roller for the application of a band formed of one or more fibers on the application surface of a mold, preferably by contact of the roller against the surface of the mold or against one or more bands previously applied on the surface of the mold, and a main guiding system for guiding at least one fiber entering into the head towards the application roller, wherein the head comprises two application rollers, including a first roller and a second roller each roller being movably mounted in relation to the main guiding system between at least an active position wherein the band is able to be guided by the main guiding system on the roller, so that the application of the band is carried out by the roller, and an inactive position, wherein the roller is remote from the main guiding system, without being in contact with the band, the head comprising an actuating system, automatic or manual, preferably automatic, able to maneuver the first roller in the active position and the second roller in the inactive position to apply a band by means of the first roller in a first direction, and to maneuver the first roller in the inactive position and the second roller in the active position to apply a band by means of the second roller in a second direction, substantially opposite to the first direction.

According to embodiments of the invention, the head comprises two application rollers, one for each direction of use of the head. When a roller is used, it is maneuvered in an low active position while the other roller is in an inactive position, high, at a distance from the main guiding system, so as not to limit the tilt angles of the head in relation to the application surface, also called laying-up surface, and enables laying up on complex surfaces, for example with large concavities and/or ramps.

The mobile mounting of the rollers in relation to the main guiding system can be performed easily, and provides a bidirectional head simple in design and implementation, of small dimensions, and guaranteeing a fiber application speed substantially similar to that of a mono-directional head.

In addition to obtaining a bidirectional head for laying up fibers in two opposite directions without requiring a reversal of the head, the head with two rollers has many other advantages.

The layup of fibers is typically carried out with a heating, particularly in the case of laying up fibers pre-impregnated with thermoplastic resins or containing a thermoplastic binder. During the layup, the roller tends to rise in temperature, and this increase in temperature leads to a deterioration of the roller. The two-roller head according to embodiments of the invention, limits these rises in temperature, without increasing the laying up time, by changing the roller used for the laying up, the unused roller in the inactive position having time to cool down. Furthermore the cooling means can also be provided to improve the cooling of each roller in the inactive position, these cooling means can for example be capable of delivering an air flow in the direction of each roller in the inactive position. Thus, the rollers of the head according to embodiments the invention deteriorate less, the head requires less changing of rollers, and results in shorter laying up times.

According to the lay-up surface, different types of rollers can be used, notably rollers made of deformable material which are more or less hard. Typically, one uses more flexible rollers, when the layup surface presents significant concavities or convexities, so that the roller can deform more and adapt itself to the surface over its entire width. It is the same when the layup surface comprises inserts of honeycomb type, in order to avoid deforming the honeycomb during layup. The head according to embodiments of the invention can be equipped with different types of rollers, and in particular of a different hardness, so that the head can be used to layup different parts, without requiring the change of rollers, or to layup the same part, but changing the roller according to the area of the part to layup, by using a first flexible roller for the areas with ramps, large concavities, large convexities and/or honeycomb, and a second less flexible roller for the flatter areas of the part.

Furthermore, according to the type of fibers laid up and the type of heating used, it is necessary to use different rollers.

The head according to embodiments of the invention can also be used with rollers of different lengths in order to adapt the length of the roller to the width of the layup band, that is to say the number of fibers constituting the band laid. For example, the head is a so-called 16 fiber head, comprising a main guiding system enabling the laying up of bands of 16 fibers. The head is equipped with rollers of different lengths, a short roller corresponding to a band of 8 fibers and a long roller corresponding to a band of 16 fibers, so that the head can be used to lay up different parts, without requiring a change of rollers, or to layup a same part, but by changing the roller according to the area of the part to layup, by using the shortest roller for complex surfaces areas, with ramps for example, and the second longest roller for the flatter areas of the part.

Putting the rollers in the inactive position, away from the main guiding system further enables easy access to the guiding system, as well as the possible fiber cutting, rerouting and blocking modules to carry out maintenance operations. The main guiding system is for example fixedly mounted on a support element of the head and the rollers are movably mounted between their two positions on the support element or on the guiding system. According to one embodiment, the head comprises a support structure by which the head is capable of being fixed to a displacement system, in particular the wrist of the end of a robot, and the support element is mounted on the support structure in a movable manner in translation and is elastically biased by at least one compaction cylinder in one direction.

According to one embodiment, each application roller is pivotally mounted around a pivoting axis arranged above its rotation axis , at least when the roller is in the active position, and parallel to the rotation axis, the maneuver of each application roller between its two positions being achieved by pivoting the roller around the pivoting axis. According to one embodiment, each application roller is rotatably mounted around its rotation axis, directly or indirectly, to the lower end of at least one arm, for example at the ends of two arms extending on either side of the main guiding system, each arm being pivotally mounted around the pivoting axis. According to one embodiment, the two rollers are pivotally mounted around a same pivoting axis, the two rollers being for example mounted on the same support module which is assembled to at least one pivoting arm, for example two pivoting arms. In this case, advantageously, the band does not pass between the two rollers, the band comes from the side of the roller in the active position which is opposite the roller in the inactive position. According to another embodiment, the head comprises two support modules, each support module bearing an application roller and is assembled, preferably in a removable manner, to at least one pivoting arm, preferably two pivoting arms.

According to one embodiment, the head is a so-called fiber placement head for the application by contact on a tool of a band largely formed of several continuous flat fibers, called tows.

According to one embodiment, the main guiding system is capable of guiding a plurality of fibers towards the application roller in the form of a band, the main guiding system comprises a first and second guiding means arranged in a staggered row according to two guide planes approaching each other from upstream to downstream to guide the fibers towards the roller in the active position in the form of two layers of fibers, the first and second guiding means comprising first channels and second channels leading onto the lower downstream edge of the main guiding system, formed for example in one or several plates, the channels leading onto the lower edge of the plate or plates, the guiding system has a mean plane, preferably a symmetry plane, the two guide planes are arranged symmetrically on either side of the mean plane, the mean plane being arranged substantially tangentially to the cylindrical surface of the roller in the active position, or beyond the cylindrical surface in relation to the rotation axis of the application roller in the active position, the rotation axes of the application roller in their active position preferably being arranged symmetrically on either side of the mean plane.

The fiber placement head advantageously includes the cutting means for cutting, preferably individually, each fiber upstream of the roller in relation to the direction of forward movement of the fibers, and the rerouting means, arranged upstream of the cutting means, to reroute each newly cut fiber in order to be able to stop and restart the application of a band at any time, as well as choose the width of the band. Advantageously, the head further comprises blocking means arranged upstream of the cutting means, capable of blocking, preferably individually, each newly cut fiber.

According to another embodiment, the head is provided for the application by contact on a tool of a band formed of a single flat fiber in the form of a wide ribbon. In this case, the head comprises a main guiding system capable of guiding a single flat fiber in the direction of the roller.

According to one embodiment, the pivoting axes of arm or arms of the first roller and of the second roller are arranged symmetrically on either side of the mean plane, the pivoting axis of the arm or arms of a roller being arranged on the side of the mean plane opposite to the axis of rotation of the roller when the latter is in the active position. This assembly limits the dimensions of the two roller head according to embodiments of the invention.

According to one embodiment, the rollers are mounted on separate support modules, each support module being capable of being maneuvered by the actuating system to displace its associated roller between its two positions.

The head according to embodiments of the invention may further be used in one direction with a single roller, the other support module being equipped by another processing device, such as for example a heating system, for example of laser type, or a trimming system, for example of ultrasound type.

According to one embodiment, the rollers are mounted on a common support module capable of being maneuvered by the actuating system for moving the rollers between their two positions. Advantageously, the common support module can be displaced in a raised position in which the two rollers are in inactive positions, to facilitate maintenance operations on the main guiding system and possibly cutting, rerouting and/or blocking modules.

According to one embodiment, the application rollers are capable of being maneuvered between their two positions by a common actuating system.

According to one embodiment, the head further comprises an additional movable guiding system mounted on the support module of each roller or two additional movable guiding systems mounted on a common movable support of the rollers, each additional guiding system being capable of guiding each fiber exiting the main guiding system towards the roller to which it is associated when the roller is in the active position. Such an additional guiding system movably mounted with the roller ensures guiding the fibers closest to the roller.

According to one embodiment, each additional guiding system comprises a first bar provided with first additional channels and second additional channels arranged in a staggered row, and coming into the extension of the first and second channels of the main guiding system in the active position of the application roller to which the additional guiding system is associated, each bar has for example an upper surface capable to come vis-a-vis the downstream edge of the main guiding system, an outer surface facing outwards, and an inner surface facing towards the application roller, the first channels and the second additional channels are open and are formed of grooves formed on the inner and outer surfaces of the bar. Preferably, each bar has a concave inner surface whose concavity corresponds to the surface of the roller, the grooves formed on the concave inner surface forming curved channels, and/or the downstream edge of the main guiding system has a cylindrical convex surface, and the bars have a concave upper surface of a corresponding shape. Advantageously, the grooves formed on the outer surfaces of the bars are covered by at least one guide plate mounted in a removable manner against the outer surfaces.

Each support module can further be equipped with a comb, as described in international patent application PCT/FR2011/052022, comprising a plurality of flexible tabs capable of coming against the fiber or fibers exiting the additional guiding system for putting the fiber or fibers in support against the roller.

According to one embodiment, the head comprises a compaction plate mounted on the support module of each roller or on the common movable support of the rollers.

According to one embodiment, the head comprises a heating system capable of emitting thermal radiation in the direction of the bands of fibers before its compaction and/or in the direction of the mold or bands of fibers already applied upstream of the compaction roller used in relation to the advancement of the direction of the head when the band is applied with the first roller in its active position or with the second roller in its active position.

According to another embodiment, the maneuver of the application rollers between their two positions is achieved by sliding of the common support module or support modules each carrying a roller in the guiding grooves.

To guarantee a substantially uniform compaction over the entire width of the band, the head advantageously comprises at least one compaction roller able to adapt itself to the application surface, notably to the convex and/or concave application surfaces. According to one embodiment, the head comprises at least one flexible roller, made of a material called flexible, elastically deformable, for example in elastomeric material, in a manner to be able to deform itself by fitting with the profile of the surfaces.

According to another embodiment, the head advantageously comprises at least one rigid segmented roller, for example metallic, comprising several roller segments independently mounted side by side on a same axial rod, each segment being moveable on the axial rod, perpendicularly to the latter, in an independent manner, and being elastically biased against the application surface by elastic means, such as expansible bag systems.

According to one embodiment, the head comprises locking means acting preferably on at least one arm, to ensure at least the locking of a roller in its active position, the locking means preferably enabling the take up of the compaction forces, and thus limiting the forces taken up at the level of the pivoting axis of the roller in the active position.

Embodiments of the present invention also concerns a fiber application machine comprising a head such as defined previously, and a system for displacing sathe id machine head, with a control unit capable of controlling the actuating system for the maneuver of the rollers between their two positions, and controlling the displacement of the head along a trajectory parameterized using two different points of origin according to the roller used.

Embodiments of the present invention also concerns a method for producing parts made of composite materials, by laying up fibers on an application surface by means of a fiber application head, the application head comprising a main guiding system for guiding at least one fiber towards the application roller, the method comprising the relative displacement of the application head in relation to the surface for applying with an application roller of the application head a band formed of one or more fibers on the application surface, wherein the method comprises
the maneuver of a first roller of the head in relation to the guiding system to bring the first roller in a low active position and the maneuver of a second roller of the head in relation to the guiding system to bring the second roller in an high inactive position, and the relative displacement of the head in a first direction in order to apply a band with the first roller,
the maneuver of the first roller of the head in relation to the guiding system to bring the first roller in an high inactive position and the maneuver of the second roller of the head in relation to the guiding system to bring the second roller in a low active position, and the relative displacement of the head in a second direction, substantially opposite to the first, to apply a band with the second roller.

According to one embodiment, the method comprises the application of the first bands with a first roller and the application of the second bands, of smaller widths than those of the first bands, with a second roller of smaller length than that of the first roller.

According to one embodiment, the method comprises the application of the first bands to with a first roller and the application of the second bands with a second roller having a capacity of greater elastic deformation than that of the first roller.

The invention will be better understood, and the other objectives, details, characteristics and advantages will appear more clearly during the following detailed explanatory description of three specific currently preferred embodiments of the invention, with reference to the appended schematic drawings.

### BRIEF DESCRIPTION OF THE DRAWINGS

FIG. 1 is a schematic perspective view of a fiber application head according to a first embodiment of the invention, the first roller being in its first active position and the second roller in its inactive position, for the application of fibers with the first roller in the first direction S1;

FIG. 2 is a front view of the head of FIG. 1;

FIG. 3 is a side view of the head of FIG. 1;

FIG. 4 is a similar view to that of FIG. 3, but with the second roller being in its active position and the first roller being in its inactive position, for the application of fibers with the second roller in the second direction S2;

FIG. 5 is a schematic perspective view of the arms and the support module of a roller of the head of FIG. 1;

FIG. 6 is a schematic side view of an application head according to a second embodiment of the invention;

FIG. 7 is a schematic perspective view of the arms and the common support module of the two rollers of the head of FIG. 6;

FIG. 8 is a schematic side view of an application head according to a third embodiment of the invention; and,

FIG. 9 is a schematic perspective view of the connecting rods and support modules of the rollers of the head of FIG. 8.

### DETAILED DESCRIPTION

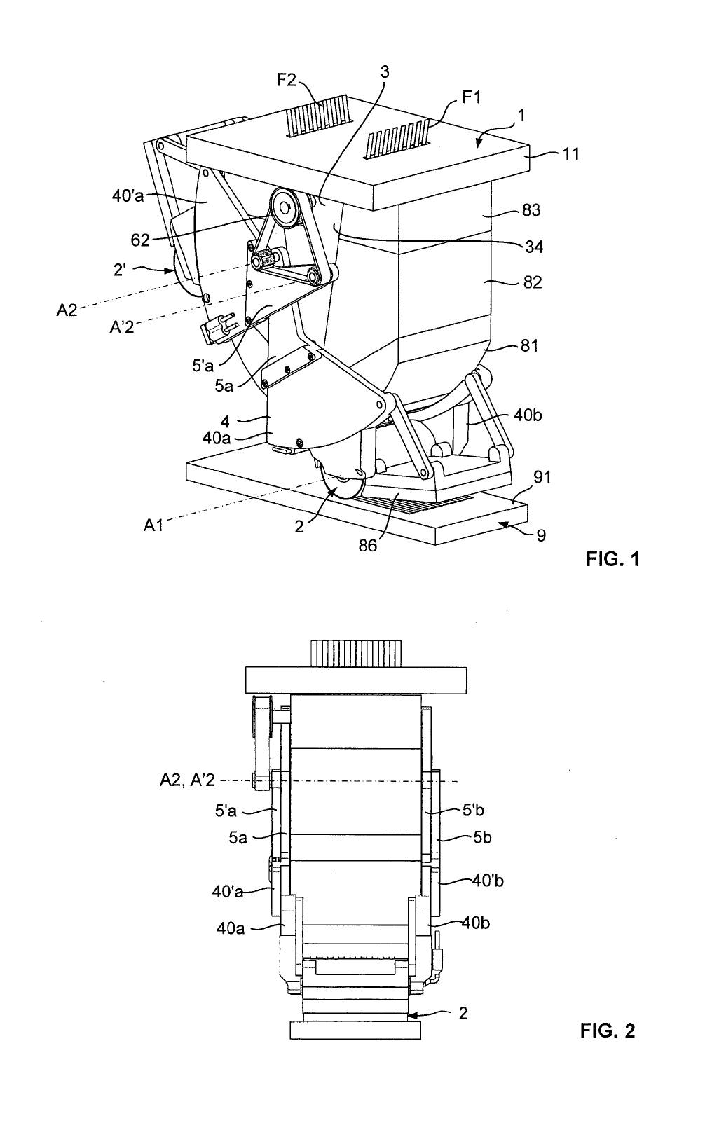

FIGS. 1 to 3 partially illustrate a fiber application head 1 according to an embodiment of the invention, provided here for the application on the application surface 91 of a mold 9 of a band formed of several fibers F1, F2, for example pre-impregnated with resin. The head 1 includes two application rollers, also called compaction rollers, a first roller referenced 2, and a second roller referenced 2′. Each roller is movable between an inactive position and an active position of layup, the head using one or the other of the rollers in the active position to layup. The head comprises a main guiding system 3 for guiding the fibers entering into the head in the direction of the roller in the active position in the form of two layers of fibers, to form a band of fibers wherein the fibers are arranged substantially edge to edge.

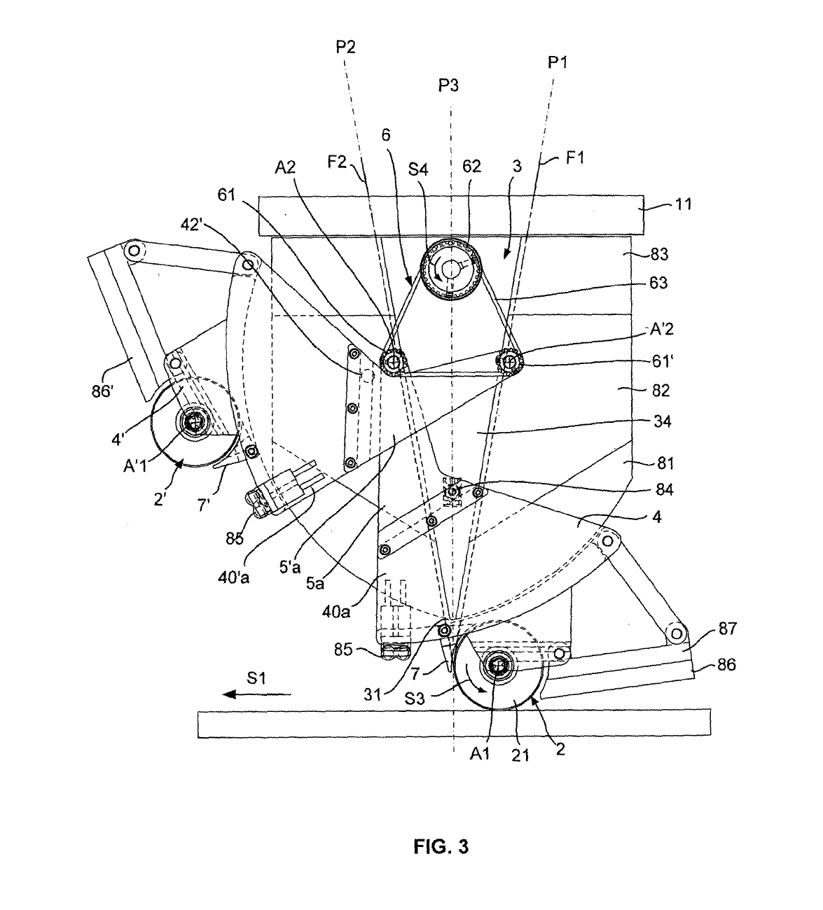

The main guiding system 3 is for example of the type that is described in the aforementioned patent document WO2008132299, and comprises three parts or plates, preferably of metal, mounted flat against each other to define between them the first guiding channels and second guiding channels through which pass respectively the first fibers Fl of the first layer and second fibers F2 of the second layer. The first and second channels lead onto the upstream edge and the downstream edge 31 (FIG. 3) of the main guiding system. The first channels and the second channels are arranged in a staggered row, along two guiding planes P1, P2 approaching each other from upstream to downstream so that the fibers F1 and F2 of the two layers are laid substantially edge to edge at the level of the application roller which is in the active position. The guiding plans P1, P2 are arranged symmetrically on either side of the mean symmetry plane P3 of the main guiding system.

The head comprises a support structure (not shown) through which the head can be connected to a displacement system capable of displacing the head in at least three directions perpendicular to each other. The displacement system comprises for example a robot comprising a wrist or multi-articulated arm at the end of which is mounted the application head. By way of example, the main guiding system 3 is assembled on a support element 11 which is intended to be movably mounted on the support structure and is biased downwards by at least one compaction cylinder (not shown) which defines the compaction force with which the fibers are applied on the mold through one of the rollers. The compaction cylinder, for example pneumatic, is pressure controlled to adjust the compaction force.

In this embodiment, the head is provided for the application of bands of sixteen fibers, each layer comprising eight fibers, the main guiding system comprising eight first channels and eight second channels.

The fibers are fed from the storage means (not shown) to the head via the conveying means (not shown). The fiber storage means can comprise a creel in the case of fibers packaged in the form of bobbins. The conveying means can be formed of flexible tubes, each tube receiving one fiber in its internal passage.

The head further comprises, on either side of the guiding system, cutting means, shown schematically under the reference 81, for individually cutting each fiber going through the guiding systems, rerouting means, represented schematically under the reference 82, for individually rerouting to the roller each newly cut fiber, as well as preferably a blocking means, shown schematically under the reference 83, to block each fiber that has just been cut.

According to embodiments of the invention, the head comprises a first roller 2 and a second roller 2′, each capable of being displaced between a low active position, called layup position, and a high inactive position. In this embodiment, each roller 2 is pivotally mounted in relation to the main guiding system 3 via pivoting arms and its own support module.

The first roller 2 is rotatably mounted around a rotation axis A1 of a support module 4, the support module is assembled at the lower ends of two arms 5a, 5b extending from each side of the lateral faces of the guiding system. Each arm is pivotally mounted on a lateral side 34 of the guiding system around a pivoting axis A2. The support module 4 comprises two support elements 40a, 40b, each support element being assembled in removable manner to an arm. The first roller is for example a flexible roller comprising a cylinder 21 made of elastomeric material mounted on a rigid axial rod, and the roller is mounted by the ends of its axial rod on parts of the support elements, the parts forming bearings. The pivoting axis A2 is offset in relation to the symmetry plane P3, the axis A2 being offset to the left of the plane P3 in FIG. 3.

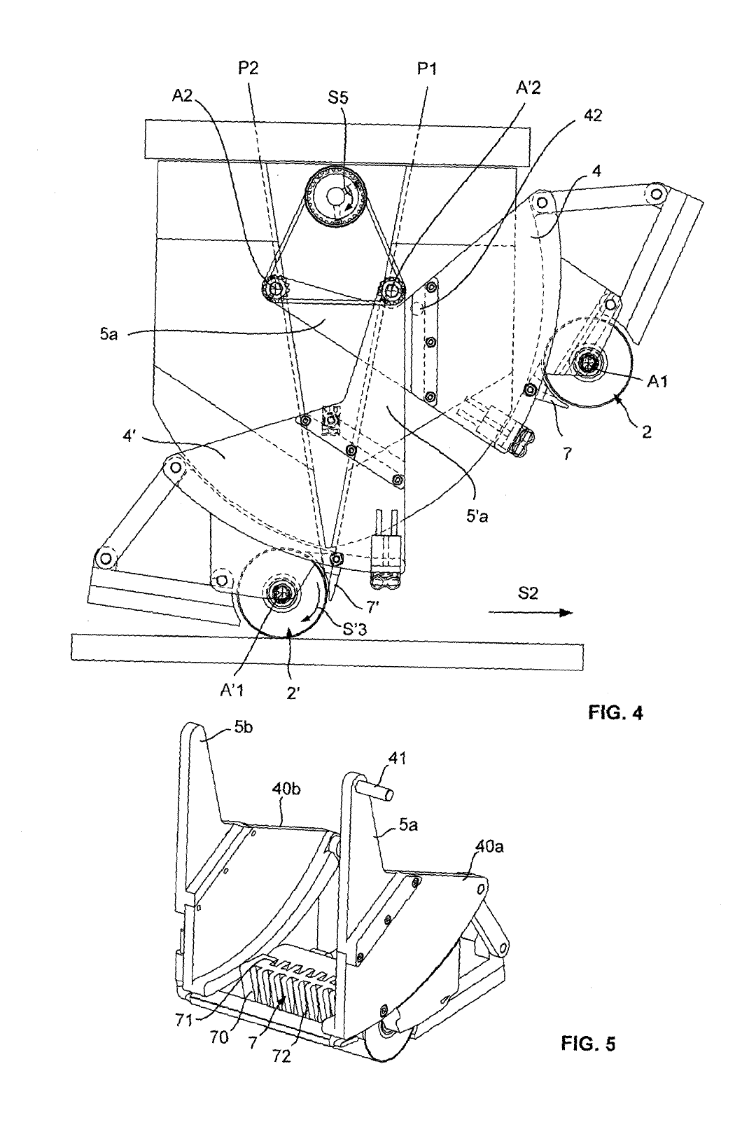

The arms 5a, 5b are capable of pivoting around the axis A2 to displace the first roller under the downstream edge 34 of the guiding system and under the cutting systems 81, between a first active position, illustrated in FIG. 3, and a second inactive position, illustrated in FIG. 4.

In the active position, the fibers exiting the main guiding system 3 are guided towards the left side of the first roller 2 to enable the laying up of the fibers with this first roller in the direction S1. The axis A1 of the first roller is positioned below the downstream edge 34 of the main guiding system from which leads the guiding channels of the fibers, and is positioned to the right of the symmetry plane P3, on the opposite side of the plane in relation to the pivoting axis A2.

In its active position, the first roller is for example positioned so that the two guiding planes P1 and P2 are substantially tangent to the cylindrical outer surface of the roller. In relation to the rotational direction S3 of the roller, the contact generatrix of the plane P1 with the surface of the roller is placed upstream of the contact generatrix of the plane P2 with the surface of the roller. The symmetry plane P3 is placed beyond the outer surface in relation to the rotation axis A1. In the inactive position illustrated in FIG. 4, the first roller is brought back above the downstream edge of the main guiding system, on the side of the plane P3 which is opposite to the axis A2, that is to the right of the plane P3 in FIGS. 3 and 4.

The support module 4 is further equipped with a movable additional guiding system 7 for guiding the fibers closest to the roller. With reference to FIG. 5, this additional guiding system comprises a bar 70 arranged parallel to the rotation axis A1 assembled by its ends to two support elements, preferably in a removable manner. Each bar has in cross section a wedge, generally triangular shape, with a so-called upper surface facing towards the main guiding system when the roller is in active position, a so-called outer surface, substantially planar, facing outwards, and a so-called inner surface, concave, facing towards the roller and the concavity of which corresponds to the surface of the roller. The bar comprises two parallel rows of additional guiding channels. The first additional channels 71 of a first row and the second additional channels 72 of the second row are arranged in a staggered row. The additional channels are open and are constituted by grooves formed on the inner and outer surfaces of the bar and lead onto the upper surface. The so-called curved first channels 71 are formed from grooves formed on the concave inner surface of the bar, and the second channels 72 are formed from grooves formed on the outer surface. For a positioning of the additional guiding system closest to the main guiding system, the downstream edge 34 of the main guiding system can have a cylindrical convex surface, the bar of the additional guiding system then has a concave upper surface of a corresponding form. In the active position, the bar is arranged vis-a-vis the downstream edge of the main guiding system, its first additional channels 71 are arranged in the extension of the first guiding channels of the first layer arranged according to the plane P1, and its second additional channels are arranged in the extension of the second channels of the second layer arranged according to the plane P2. To guarantee the holding of the fibers in the grooves forming the second channels 72, they are closed by a guide plate (not shown) mounted in a removable manner on the bar, against the outer surface.

The module is further equipped with heating means constituted here of an infrared lamp 85 for heating the fibers exiting the additional guiding system, and/or the mold or the bands of fibers already applied upstream of the compaction roller, just before the compaction of the band by the first roller, in order to at least soften the pre-impregnation resin, in the case of pre-impregnated fibers, or the binder in the case of dry fibers, and thereby promote the adhesion of the bands between themselves. The lamp 85 is mounted on at least one of the two support elements and is arranged downstream of the first roller relative to the layup direction S1.

The module is equipped with a compaction plate 86 arranged downstream of the roller in relation to the direction of advancement of the placement head, this plate ensures a compaction over the entire width of the band during the corner passages, such as described in the patent document EP 2 414 152. The plate, made of a deformable material, is mounted on a plate support 87. The plate support is here pivotally assembled by its upstream part to the support elements 40a, 40b, behind the first roller in relation to the direction of advancement S1 of the head, and is connected by its downstream part to the support elements by connecting rods. Connecting rods adjustable in length or the set of connecting rods of different lengths can be used to adjust the plate angle to the desired value.

In a similar manner, the second roller 2′ is rotatably mounted around a rotation axis A′1 on a support module 4′ which is assembled to the lower ends of the two arms 5′a, 5′b. Each arm is pivotally mounted on a lateral side 34 of the guiding system around a pivoting axis A′2. The support module 4′ comprises two supporting elements 40′a, 40′b assembled in a removable manner to the arms. The second roller is rotatably mounted on bearings of the support elements. The axes A2 and A′2 are arranged symmetrically on either side of the plane P3, the axis A′2 being offset to the right of the plane P3 in FIG. 3. The arms 5′a, 5′b are capable of pivoting around the pivoting axis A′2 for moving the second roller under the downstream edge of the guiding system and under the cutting systems, between first active position, illustrated in FIG. 4, and a second inactive position, illustrated in FIG. 3. In the active position, the fibers exiting the main guiding system are guided towards the right side of the second roller to allow the laying up of the fibers with the second roller in the direction S2. The axis A′1 of the second roller is positioned below the downstream edge of the main guiding system, and is positioned to the left of the symmetry plane P3, in the opposite side of the plane in relation to the pivoting axis A′2. In its active position, the second roller is for example positioned so that the two guide planes P1 and P2, are substantially tangent to the cylindrical outer surface of the roller. In relation to the rotation direction S′3 of the roller, the contact generatrix of the plane P1 with the outer surface of the roller is arranged downstream of the contact generatrix of the plane P2 with the outer surface of the roller. The symmetry plane P3 is arranged beyond the outer surface in relation to the rotation axis A′1. In the inactive position illustrated in FIG. 3, the roller is brought back above the downstream edge of the guiding system, on the side of the plane that is opposite to the axis A′2, that is on the left of the plane P3 in FIGS. 3 and 4.

The support module of the second roller is equipped with an additional guiding system 7′ and a compaction plate 86′, identical to those equipping the support module of the first roller. In the active position, the additional guiding system 7′ is arranged vis-a-vis the downstream edge of the main guiding system, its first additional channels 71 are arranged in the extension of the second guiding channels of the first layer arranged according to the plane P1, and its second additional channels are arranged in the extension of the first channels of the second layer arranged according to the plane P2.

When the first roller is in the active position, the second roller is in the inactive position, and conversely, when the first roller is in the inactive position, the second roller is in the active position.

The pairs of arms 5a, 5b, 5′a, 5′b associated to the rollers are offset one in relation to the other transversely, in the direction of the pivoting axes. The pairs of arms are the identical for both rollers. As visible in FIG. 5, the arms of a same pair have different lower assembly parts to take into account this transverse offset and obtain an identical transversal positioning of the two rollers in their active position.

In this embodiment, the rollers 2, 2′ are maneuvered between their two positions by a common actuating system 6. The arms 5a and 5′ each carry a pin 41 (FIG. 5) on which is fixedly mounted a pinion 61, 61′. A drive pinion 62 is linked to the shaft of a common motor (not shown), and a toothed belt 63 is mounted on the three pinions 61, 61′, 63. When the first roller is in the active position and the second roller is in an inactive position such as illustrated in FIG. 3, the motor is controlled to drive in rotation the drive pinion, in the anticlockwise direction such as illustrated by the arrow S4, in a manner to drive the arms 5a, 5′a in an anticlockwise direction, as far as to bring the first roller to its inactive position and the second roller to its active position, such as illustrated in FIG. 4. The return of the rollers, from their position illustrated in FIG. 4 to their position illustrated in FIG. 3, is obtained by controlling the motor to drive in rotation the drive pinion in the clockwise rotation S5.

Locking means are preferably provided to ensure at least the locking of a roller in its active position. These locking means comprise two cylinders 84 mounted in the main guiding system and whose rods, arranged parallel to the pivoting axes, are capable of being displaced in an active position, projecting in relation to the lateral sides of the main guiding system. In the active position, the cylinder rods come in an opening or recess 42, 42′ of the arms associated to the roller which is in the active position. These locking means further allow the take up of the compacting forces, and limit the forces taken up at the level of the pivoting axis of the roller in the active position.

For the layup of a band of fiber on a mold in the left direction S2, the first roller is brought into its active position. The fibers F1, F2 guided in the channels of the main guiding system 3 are then guided in the additional channels of the bar 70 to then be applied on the mold by the first roller, the first roller rotates in the anticlockwise direction S3. For the layup of a band of a fiber in the right direction S2, the second roller is brought into its active position. The fibers Fl, F2 exiting the channels of the main guiding system are guided in the additional channels of the additional guiding system 7′, to then be applied on the mold by the roller rotating in the clockwise direction S′3.

The fiber application machine equipped with a head according to embodiments of the invention comprises a control unit capable of controlling the maneuver of the rollers between their positions. In the programming software of the control unit, the trajectory of the head is set depending on the roller used. The origin point for defining the trajectory corresponds for example to the middle of the generatrix of the roller used at the contact of the layup surface, two different points of origin being used depending on the roller used.

Alternatively, the actuating system comprises at least one cylinder acting on an arm carrying one of the rollers, the arm being linked by a connecting rod to an arm carrying the other roller. The cylinder body is for example fixedly mounted in relation to the main guiding system and the end of its piston rod is assembled to the arm of the roller. Preferably, the two arms associated to a roller are each actuated by a cylinder, and each of the arms is linked by a connecting rod to an arm of the other roller. This actuating system enables easier adjustment of the angle between the two pairs of arms.

In this illustrated embodiment, the support modules are provided for the mounting of a compaction plate. Preferably, the pairs of arms are provided for the assembly of different modules, the support modules differentiating themselves from one another for example by:
the lengths of the rollers, for example a roller for 16 fibers and a roller 8 for fibers ;
a segmented metal roller and roller of a deformable flexible material ;
from rollers of a deformable material of different hardnesses for example rollers of elastomeric material having different densities ;
presence or not of a compaction plate ; and/or
different heating systems.

According to an alternative embodiment, the head comprises a common heating system for heating in both the directions S1, S2. The support modules 4, 4′ of the two rollers are for example linked by one or more connecting rods. These connecting rods, linked in a pivoting manner by their ends to the support modules, carry one or more infrared lamps. Alternatively, the heating system is of the laser type. A laser source, offset in relation to the head, is connected, for example via an optical fiber waveguide to an optic system mounted on the main guiding system, movable between an inactive position and two active positions to ensure the heating of the fibers respectively during layup in the direction S1 and in the direction S2.

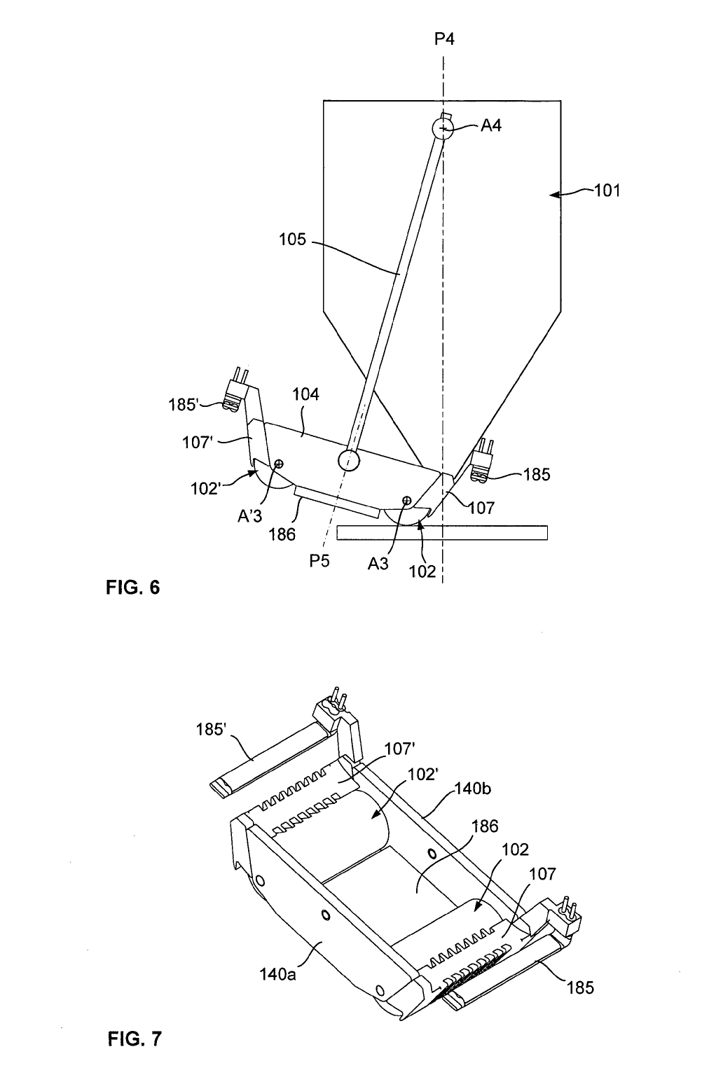

FIGS. 6 and 7 illustrate a second embodiment of a head 101 with two rollers according to embodiments of the invention, wherein the two rollers are mounted on the same support module. The support module 104 comprises two support elements 140a, 140b. The first roller 102 and the second roller 102′ are rotatably mounted around axes of rotation A3, A′3, between the two support elements, the axes being arranged symmetrically on either side of the symmetry plane P5 of the support module. The support module is assembled to the lower ends of two arms 105 extending from both sides of the lateral sides of the guiding system. Each arm is pivotally mounted on a lateral side of the guiding system around a pivoting axis A4, arranged according to the symmetry plane P4 of the main guiding system, and is assembled, preferably in a removable manner at the level of the symmetry plane P5 to a support element 140a, 140b. The support module is equipped with additional guiding systems 107, 107′, similar to those described previously, mounted between the two supporting elements, arranged symmetrically on either side of the plane P5, on the outer side of the rollers, as well as an infrared lamp 185, 185′ for each layup direction. The arm 105 are capable of pivoting around the pivoting axis A4 to displace the support module between two positions, a first position of the support module in which the first roller is in the active position to layup in a first direction and the second roller is in the inactive position, such as illustrated in FIG. 6, and a second position of the support module in which the first roller is in the inactive position and the second roller in the active position to layup in a second direction opposite to the first one. A compaction plate 186 is mounted between the two support elements, between the two rollers, this single plate being operable in both directions, so that the fibers are laid up with the first roller or the second roller. The actuating system (not shown) is for example formed of a cylinder whose body is fixedly mounted on the head in relation to the guiding system and whose cylinder rod is assembled to an arm.

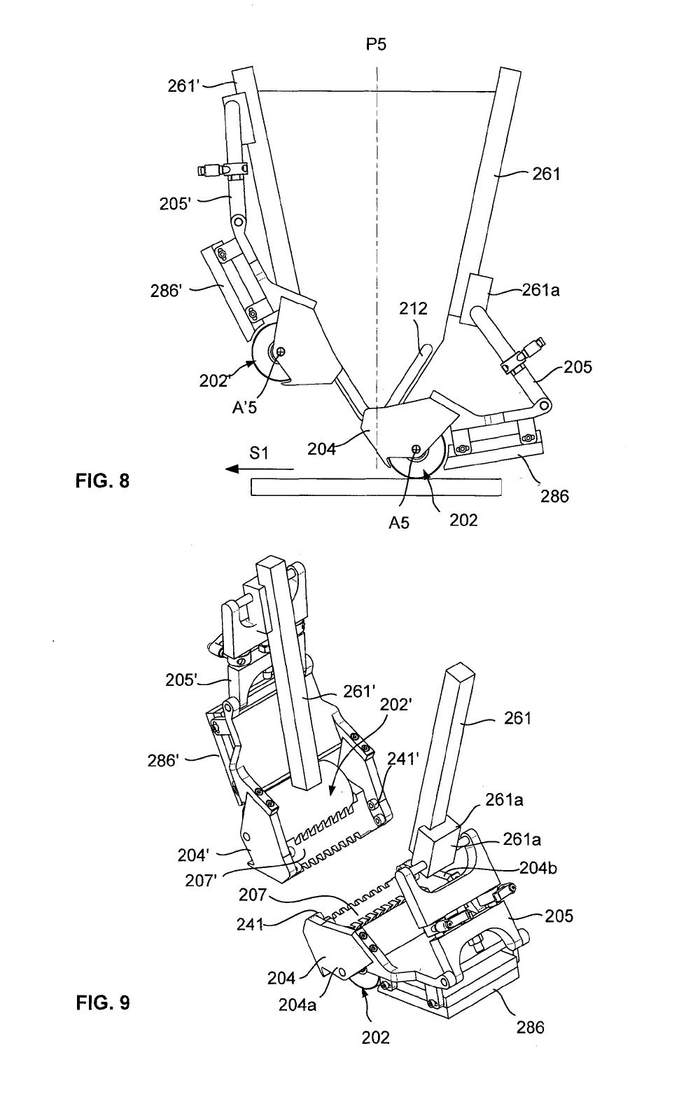

FIGS. 8 and 9 illustrate a third embodiment of a head 201 with two rollers according to the invention, wherein each roller is mounted on a sliding support module displaced by a connecting rod system.

The first roller 202 is rotatably mounted around a rotation axis AS between the two support elements 240a, 240b of the support module 204, the support module is mounted sliding on the main guiding system or a support of the head on which is mounted the main guiding system. For this sliding mounting, each support element 204a, 204b comprises for example two wheels 241, and the head is provided with two lateral grooves 212, generally V-shaped, formed on its lateral sides, for example on a support frame of the head or on the main guiding system. The wheels of the support elements are engaged in the grooves and are capable of sliding in the latter. The support module carries an additional guiding system 207, as well as a compaction plate 286, such as described previously. The activation of the roller in an active position and an inactive position is performed by means of a connecting rod 205 assembled in a pivoting manner, by one end to the downstream part of the module 204 and by its other end to a cylinder 261. In the example illustrated, the connecting rod is assembled to the carriage 261a of a rodless cylinder, preferably guided, known per se. The connecting rod is adjustable in length to adjust the angle of the compaction plate. In a similar manner, the second roller 202′ is rotatably mounted around an axis A′S on a support module 204′. The support module carries the wheels 24 sliding in the groove 212, an additional guidance system 207′, and a compaction plate 286′, and is displaced by a connecting rod 205′ linked to a cylinder 206′.

For the layup of the fiber in a first direction S1, the first roller 202 is in its active position and the second roller is in its inactive position, such as illustrated in FIG. 8. To layup in the opposite direction, the cylinder 261 of the first module 204 is controlled to raise the first roller 202 in its inactive position, its wheels 241 sliding in the groove 212, and the cylinder 261′ of the second module 204′ is controlled to lower the second roller 202′ in its active position.

A heating system can be mounted on each support module 204, 204′. Alternatively a heating system, such as an IR lamp is pivotally mounted on the guiding system around an axis parallel to the mean plane PS, to be maneuvered between an inactive position enabling the raising/lowering of the rollers, and an active heating position.

Although the invention has been described in conjunction with several specific embodiments, it is obvious that it is in no way limited thereto and includes all technical equivalents of the described means as well as their combinations if they are within the scope of the invention.

1. A fiber application head for producing parts made of composite materials, comprising at least one application roller for the application of a band formed of one or more fibers on the application surface of a mold, and a main guiding system for guiding at least one fiber towards said application roller,
characterized in that said head comprises two application rollers including a first roller and a second roller, each roller is movably mounted in relation to said main guiding system between at least an active position wherein said band is capable of being guided by the main guiding system on the roller, and an inactive position, in which said roller is remote from the main guiding system, without being in contact with the band,
the head comprising an actuating system adapted to maneuver the first roller in the active position and the second roller in the inactive position for applying a band by means of the first roller, and to maneuver the first roller in the inactive position and the second roller in the active position for applying a band by means of the second roller.

2. The fiber application head according to claim 1, wherein each application roller is pivotally mounted around a pivoting axis arranged above its rotation axis, and parallel to said axis of rotation, the maneuver of each application roller between its two positions being achieved by pivoting of said roller around, said pivoting axis.

3. The fiber application head according to claim 2, that wherein each application roller is rotatably mounted around its rotation axis to the lower end of at least one arm, each arm being pivotally mounted around said pivoting axis.

4. The application head according to claim 3, further comprising two support modules, each support module carrying an application roller operable assembled, in a removable manner to at least one pivoting arm.

5. The fiber application head according to claim 1, wherein said main guiding system is capable of guiding a plurality of fibers towards the application roller in the form of a band, the main guiding system comprises first and second guiding means arranged in staggered rows along two guiding planes approaching each other from upstream to downstream to guide the fibers towards the roller in the active position in the form of two layers of fibers, the first and second guiding means comprising first channels and second channels leading onto the downstream edge of the main guiding system, said guiding system having a mean plane, the two guiding planes are arranged symmetrically on either of side of the mean plane, said mean plane being arranged substantially tangentially to the cylindrical surface of the roller in the active position or beyond said cylindrical surface in relation to the rotation axis of said application roller in the active position.

6. The fiber application head according to claim 4, wherein the pivoting axes of the arms of the first roller and the second roller are arranged symmetrically on either side of the mean plane, the pivoting axis of the arm or arms of a roller being arranged on the side of mean plane opposite to the rotation axis of said roller when the latter is in the active position.

7. The fiber application head according to claim 1, wherein the rollers are mounted on separate support modules, each support module being capable of being maneuvered by said actuating system to displace its associated roller between its two positions.

8. The fiber application head according to claim 1, wherein said rollers are mounted on a common support module capable of being maneuvered by said actuating system for moving said rollers between their two positions.

9. The fiber application head according to claim 7 , further comprising an additional guiding system mounted on the support module of each roller or two additional guiding systems mounted on the common movable support of the rollers, each additional guiding system being capable of guiding each fiber exiting the main guiding system towards the roller to which it is associated, when said roller is in the active position.

10. The fiber application head according to claim 7, comprising a compaction plate mounted on the support module of each roller or on the common mobile support of the rollers.

11. The fiber application head according to claim 7, comprising a heating system capable of emitting thermal radiation in the direction of the band of fibers before its compaction and/or in the direction of the mold or bands of fibers already applied when said band is applied with the first roller in its active position or with the second roller in its active position.

12. The fiber application head according to claim 1, comprising locking means, to ensure at least the locking of one roller in its active position, said locking means enabling the take up of the compaction force.

13. A method for producing parts made of composite material, by laying up fibers on an application surface by means of a fiber application head, said application head comprising a main guiding system for guiding at least one fiber towards said application roller, said method comprising the relative displacement of the application head in relation to the application surface to apply with art application roller of said application head a band formed of one or more fibers on the application surface comprising:
the maneuver of a first roller of the head in relation to the guiding system to bring said first roller in an active position and the maneuver of a second roller of the head in relation to the guiding system to bring said second roller Lu an inactive position, without contact with the band, and the relative displacement of the head in a first direction in order to apply a band with the first roller,
the maneuver of the first roller of the head in relation to the guiding system to bring said first roller in an inactive position, without contact with the band, and the maneuver of the second roller of the head in relation to the guiding system to bring said second roller into an active position, and the relative displacement of the head in a second direction, substantially opposite to the first, in order to apply a band with the second roller.

14. The method according to claim 13, comprising the application of first hands with a first roller and application of second bands, of smaller widths than those of the first bands, with a second roller, of a shorter length than that of the first roller.

15. The method according to claim 13, comprising the application of first bands with a first roller and the application of second hands with a second roller having a capacity of elastic deformation greater than that of the first roller.
